(19) United States
(12) Patent Application Publication
(10) Pub. No.: US 2020/0094624 A1
(43) Pub. Date: Mar. 26, 2020

(54) ADJUSTABLE AIRLESS TIRE SYSTEM

(71) Applicants: Hai Huang, (US); Tony Huang, (US)

(72) Inventors: Hai Huang, Herndon, VA (US); Tony Huang, Herndon, VA (US)

(73) Assignees: Hai Huang, Herndon, VA (US); Tony Huang, Herndon, VA (US)

(21) Appl. No.: 16/137,436

(22) Filed: Sep. 20, 2018

(51) Int. Cl. B60C 7/10; B60C 7/06

(52) U.S. Cl. CPC B60C 7/10; B60C 7/22; B60C 7/06

(57) ABSTRACT

An adjustable airless tire system includes supporting rods connecting with walls of a tire and a metallic hawser loop, which transfer a load of a vehicle from a ground contact surface of the tire to whole walls of the tire. A sensor detects a tension of the tire and a variation of the tension during driving. A control component adjusts the tension of the tire according the load of the vehicle and the road conditions to improve its oil saving, comfortability, controllability and safety. A rim of a wheel keeps an appropriate distance from the tire to limit the maximal level of downward movement of the supporting rods, and support the load of the vehicle if the tire is overload or the supporting rods lose their function. A curved tire forms closed space between the tire and the rim of the wheel to prevent sticking of foreign objects between them.

### FIELD OF THE DISCLOSURE

The present disclosure generally relates to the field of an adjustable airless tire system and, more particularly, relates to a system of the adjustable airless tire with a metallic hawser loop and supporting rods to imitate an internal inflated tire, and a sensor and a control component to regulate a tension of the tire according road conditions, which possess its advantages of affordable, comfortability, controllability and safety.

### BACKGROUND

Current internal inflated tires provide a good buffering for a vehicle by transferring a load of the vehicle from a ground contact surface of a tire to whole walls of the tires through air within the tires. But, the biggest disadvantage for the internal inflated tires is air leaking.

Nowadays, there are many types of airless tires. But, they cannot transfer the vehicle load from the ground contact surface to whole walls of the tires, and just provides limited buffering for the vehicle from the ground contact surface of the tires. In addition, they need special materials that must have enough hardness to support the load of the vehicle as well as enough elastic to provide good buffering for the vehicle. As the result, they will be expensive.

Road conditions may be different, such as a rough road or slippery one, which need different tension of the tire to keep comfortability, stability and safety during driving. But, current tires cannot adjust the tension of the tire according changes of the load of the vehicle or the road conditions.

The invention designs adjustable tire with a metallic hawser loop and supporting rods to transfer the load of the vehicle from the ground contact surface of the tire to whole walls of the tires, which imitates the inflated tires to provide good buffering for the vehicle. At the same time, a sensor and a control component can regulate the tension of the tire according to the conditions of the road. The tire is elastomeric and easy to change. The adjustable airless tire system in the invention improves affordable, comfortability, controllability and safety.

### BRIEF SUMMARY OF THE DISCLOSURE

The present disclosure includes an adjustable airless tire system with a metallic hawser loop and supporting rods to transfer a load of a vehicle from a ground contact surface of the tire to whole walls of the tire, which imitates a mechanism of an internal inflated tire to provide good buffering.

At the same time, by detecting a tension of the tire with a sensor, a control component will regulate extension of the metallic hawser loop, which regulates the tension of the tire. As the result, a size of the ground contact surface of the tire will change according the load of the vehicle or road situations, which improve its oil saving, comfortability, controllability and safety during driving.

Utilizing any suitable elastomer and all types of reinforcing materials as similar as the internal inflated tire, the adjustable airless tire is economic and affordable. Its curved shape provides a closed space between a rim of a wheel and the tire to prevent foreign objects sticking between them.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 is a view schematically showing an adjustable airless tire system related to the present invention.

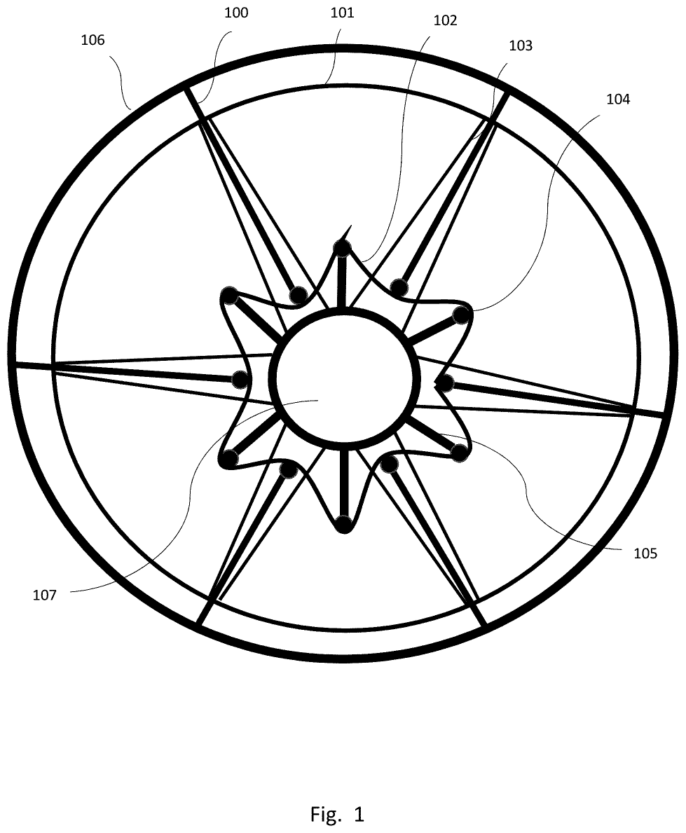

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

The invention contains a metallic hawser loop 102 and supporting rods 100 to transfer a load of a vehicle from a ground contact surface of a tire to whole walls of the tire 106, which imitates an internal inflated tire to provide good buffering for the vehicle.

The supporting rods made with steel connect the metallic hawser loop and walls of the tire. One ends of the supporting rods is set up with bearing that contact with the metallic hawser loop to smooth its movement, and another end of the supporting rods is fixed with a curved plate to better support the walls of the tire. As the ground contact surface of the tire compress the corresponding supporting rods, they will compress a corresponding section of the metallic hawser loop downward. The downward metallic hawser loop will tighten other sections of the metallic hawser loop, which push other supporting rods upward to compress other parts of the walls of the tires. By this way, the load of the vehicle is transferred from the ground contact surface of the tire to whole walls of the tire through the system of the metallic hawser loop and the supporting rods, which imitates the mechanism of an internal inflated tire to provide good buffering. Parallelly arranging several metallic hawser loops and the supporting rods to support different parts of the walls of the tire will provide more even proportionate tension and better buffering to the tire.

A sensor and a control component containing in a control box 107 locate at a hub of a wheel. The sensor will detect the tension of the tire to calculate the load of the vehicle, and will give alert if the tire is overloaded. It also detects a variation of the tension of the tire during driving to judge road condition. An increased variation of the tension of the tire during driving suggests rougher condition of the road.

The control component 105 contains control rods to support the metallic hawser loop. A bearing is fixed at its one end of the control rods to smooth its movement on the metallic hawser loop. The control component can prolong or contract the control rods to regulate extension of the metallic hawser loop to regulate the tension of the tire through the supporting rods. Regulating the tension of the tire will improve oil saving, comfortability, controllability and safety during driving. First, according the load of the vehicle to regulate the tension of the tire can optimize a size of the ground contact surface of the tire with the road, which saves oil; Second, driving on the rough road, severe shaking of the tire will increase the variation of the tension of the tire. Reducing the tension of the tire will reduce riding vibration to improve the comfortability; Third, driving on a slippery road condition, such as raining or snowing, decreasing the tension of the tire will increase the size of the ground contact surface of the tire with the road, which improves the controllability and safety of the vehicle during driving.

A steel rim 101 of the wheel keeps appropriate distance from the tire to limit the maximal level of downward movement of the supporting rods, and support the load of the vehicle if the tire is overload or the supporting rods lose their function. The steel rim is supported from steel frames 103 with their one ends fixed at center area of the wheel.

The tire 106 is made of any suitable elastomer with all types of reinforcing materials that is similar as the internal inflated tire to help support the load of the vehicle and enhance its performance. A shape of the tire is curved as the internal inflated tires to form closed space between the tire and the rim of the wheel with its two sides mounted within the rim flange of the wheel, which prevents foreign objects, such as stones, from sticking between the tire and the rim during driving.

Other applications, advantages, alternations, modifications, or equivalents to the disclosed embodiments are obvious to those skilled in the art and are intended to be encompassed within the scope of the present disclosure.

What is claimed is:

1. An adjustable airless tire system comprising:
a plurality of spoke structure of supporting rods extending between a metallic hawser loop and walls of a tire;
the metallic hawser loop pushing the supporting rods toward the tire, and the metallic hawser loop being supported and regulated through control rods of a control component;
a sensor checking tension of the tire, and the control component regulating prolongation or contraction of the control rods;
a rim of a wheel keeping appropriate distance from the tire; and
the tire being curved to make a closed space between the tire and the rim of the wheel.

2. The adjustable airless tire system according to claim 1, wherein the supporting rods comprise a curved plate at one end to contact with the walls of the tire, and a bearing at another end to contact with the metallic hawser loop.

3. The adjustable airless tire system according to claim 1, wherein the metallic hawser loop distributes the load of the vehicle from the ground contact surface of the tire to whole walls of the tire through the supporting rods.

4. The adjustable airless tire system according to claim 3, wherein parallelly arranging several metallic hawser loops and the supporting rods increase supporting sites of the tires.

5. The adjustable airless tire system according to claim 1, wherein the sensor detects the tension of the tire to calculate the load of the vehicle, and a variation of the tension of the tire during driving to estimate roughness of a road.

6. The adjustable airless tire system according to claim 1, wherein the control component prolongs or contracts the control rods to regulate extension of the metallic hawser loop, which affects the tension of the tire through the supporting rods.

7. The adjustable airless tire system according to claim 1, wherein the rim of the wheel keeps an appropriate distance from the tire to limit the maximal level of downward movement of the supporting rods, and supports the load of the vehicle if the tire is overloaded or the supporting rods lose their function.

8. The adjustable airless tire system according to claim 1, wherein the tire is elastomeric with all types of reinforcing materials, and with its curved shape to make a closed space between the tire and the rim of the wheel.
